(19) United States
(12) Patent Application Publication
(10) Pub. No.: US 2026/0099629 A1
(43) Pub. Date: Apr. 9, 2026

(54) SECRECY INQUIRY DEVICE, SECRECY INQUIRY METHOD, AND RECORDING MEDIUM

(71) Applicant: NEC Corporation, Tokyo (JP)

(72) Inventors: Kosuke KIHARA, Tokyo (JP); Junki MORI, Tokyo (JP); Kazuya KAKIZAKI, Tokyo (JP); Isamu TERANISHI, Tokyo (JP)

(73) Assignee: NEC Corporation, Tokyo (JP)

(21) Appl. No.: 19/335,449

(22) Filed: Sep. 22, 2025

(30) Foreign Application Priority Data
Oct. 3, 2024 (JP) 2024-174096

(51) Int. Cl. G06F 21/62

(52) U.S. Cl. CPC G06F 21/6254

(57) ABSTRACT

In a secrecy inquiry device, a generalization means replaces a specific expression of an attribute included in input text with a general expression. A communication means transmits the text in which the specific expression is replaced with the general expression to an external LLM and receives a response from the external LLM. A correction means corrects, in a case where the general expression is altered by the external LLM, the altered general expression in the response to the original general expression based on a tendency in alteration by an LLM. A decoding means decodes the general expression into the specific expression.

### INCORPORATION BY REFERENCE

This application is based upon and claims the benefit of priority from Japanese patent application No. 2024-174096, filed on October 3, 2024, the disclosure of which is incorporated herein in its entirety by reference.

### TECHNICAL FIELD

The present disclosure relates to a technique for concealing information.

### BACKGROUND ART

In recent years, large language models (LLMs) have been utilized in fields such as business and education. For example, Patent Document 1 discloses a technique of supporting an educational service using a large language model.

Patent Document 1: Japanese Patent 7542164 B1

### SUMMARY

In a case where a user inputs personal information or confidential information to an external LLM, the information is used for training of the LLM, and there is a possibility of information leakage to a third party. According to Patent Document 1, the risk of the information leakage is reduced by not transmitting the personal information of the user to the outside. However, according to the method described above, it is difficult to obtain, from the LLM, a response equivalent to that in the case of including the personal information. The personal information may not necessarily be protected appropriately even by the method of Patent Document 1.

An object of the present disclosure is to provide a secrecy inquiry device capable of transmitting concealed text to an LLM and appropriately decoding a response obtained from the LLM.

According to an example aspect of the present invention, there is provided a secrecy inquiry device, including:

at least one memory configured to store instructions; and

at least one processor configured to execute the instructions to:

replace a specific expression of an attribute included in input text with a general expression;

transmit the text in which the specific expression is replaced with the general expression to an external LLM and receive a response from the external LLM;

correct, in a case where the general expression is altered by the external LLM, the altered general expression in the response to the original general expression based on a tendency in alteration by an LLM; and

decode the general expression into the specific expression.

According to another example aspect of the present invention, there is provided a secrecy inquiry method including:

replacing a specific expression of an attribute included in input text with a general expression;

transmitting the text in which the specific expression is replaced with the general expression to an external LLM and receiving a response from the external LLM;

correcting, in a case where the general expression is altered by the external LLM, the altered general expression in the response to the original general expression based on a tendency in alteration by an LLM; and

decoding the general expression into the specific expression.

According to a further example aspect of the present invention, there is provided a recording medium recording a program for causing a computer to execute processing including:

replacing a specific expression of an attribute included in input text with a general expression;

transmitting the text in which the specific expression is replaced with the general expression to an external LLM and receiving a response from the external LLM;

correcting, in a case where the general expression is altered by the external LLM, the altered general expression in the response to the original general expression based on a tendency in alteration by an LLM; and

decoding the general expression into the specific expression.

### EFFECT

According to the present disclosure, concealed text may be transmitted to an LLM, and a response obtained from the LLM may be appropriately decoded.

### BRIEF DESCRIPTION OF THE DRAWINGS

FIG. 1 is a diagram conceptually illustrating a technique according to the present disclosure;

FIG. 2 is a block diagram illustrating a hardware configuration of a secrecy inquiry device according to the present disclosure;

FIG. 3 is a block diagram illustrating a functional configuration of the secrecy inquiry device according to the present disclosure;

FIG. 4 is a diagram for explaining processing by an alteration correction unit;

FIG. 5 is a flowchart of a process to be performed by the secrecy inquiry device according to the present disclosure;

FIG. 6 is a flowchart of the processing by the alteration correction unit;

FIG. 7 is an example of a confirmation screen;

FIG. 8 is an example of a registration screen;

FIG. 9 is a block diagram illustrating a functional configuration of another secrecy inquiry device according to the present disclosure; and

FIG. 10 is a flowchart of a process to be performed by the another secrecy inquiry device according to the present disclosure.

### EXAMPLE EMBODIMENTS

Hereinafter, preferred example embodiments of the present disclosure will be described with reference to the drawings.

### First Example Embodiment

### Overall Configuration

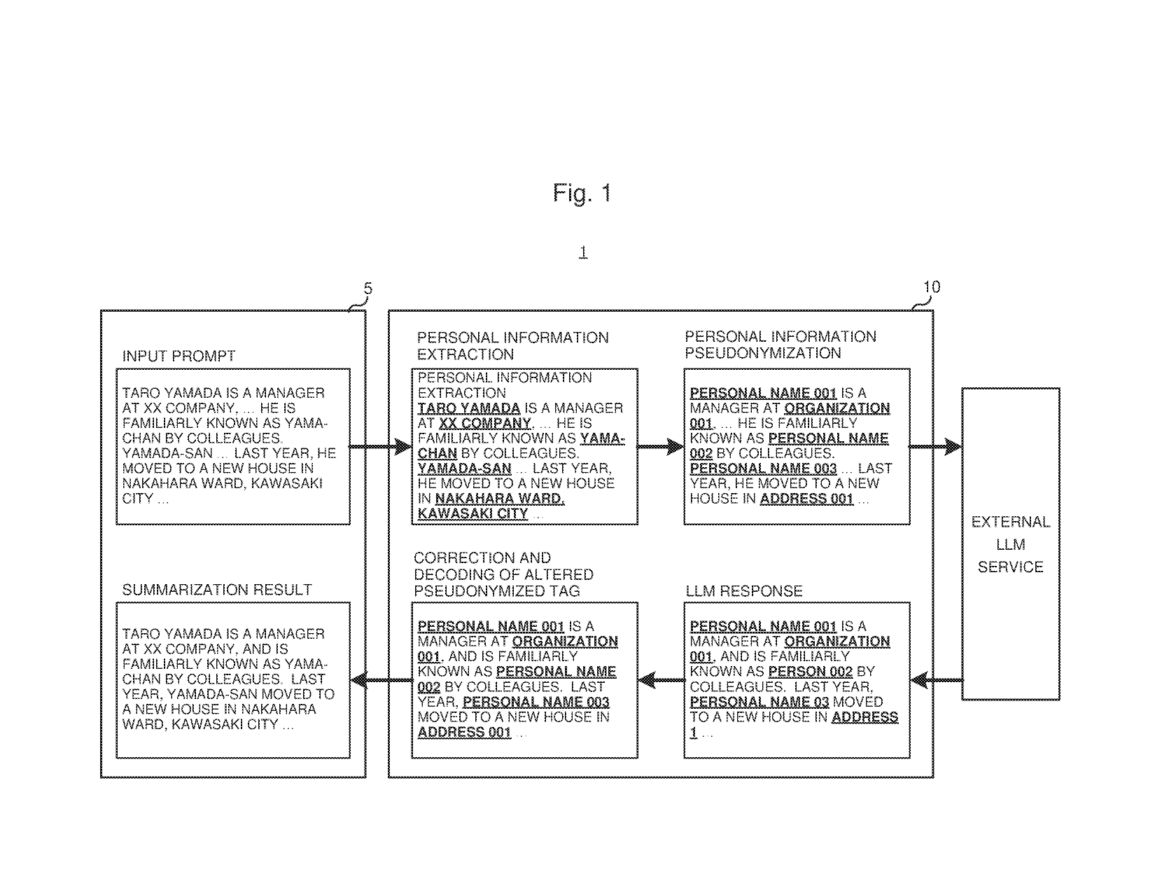

FIG. 1 is a diagram conceptually illustrating a technique according to the present example embodiment. FIG. 1 includes a terminal device 5, a secrecy inquiry device 10, and an external LLM service. The terminal device 5 and the secrecy inquiry device 10 may communicate with each other in a wired or wireless manner. Examples of the external LLM service include ChatGPT of OpenAI, Inc., and the external LLM service will also be simply referred to as “LLM” hereinafter.

The terminal device 5 is operated by a user of the LLM or the like, and transmits a prompt input by the user to the secrecy inquiry device 10. The prompt is text to be input to the LLM. For example, the user transmits, as a prompt, original text to the secrecy inquiry device 10 in a case where the user desires to, for example, summarize the text or proof the text. In the present example embodiment, it is assumed that the user summarizes the text. The terminal device 5 includes, for example, a personal computer.

The secrecy inquiry device 10 appropriately controls transmission and reception of information between the terminal device 5 and the LLM. Specifically, the secrecy inquiry device 10 makes an inquiry to an external LLM after concealing personal information included in the prompt. The secrecy inquiry device 10 includes, for example, a server device and the like, and communicates with the external LLM through a network such as the Internet.

Examples of the personal information in the present example embodiment include personally identifiable information (PII), which is information by which an individual can be identified. The personal information in the present example embodiment is assumed to include a direct identifier, such as a full name, a mobile number, a residence address, a mail address, an individual number, and a bank account of an individual, and an indirect identifier, such as a demographic feature (gender, age, height, weight, race, ethnic group, etc.), a place of employment, a date such as a date of birth, and an acquaintance of the individual.

### Outline of Concealment and Decoding

### Concealment

Next, an outline of concealment of personal information by the secrecy inquiry device 10 according to the present example embodiment will be described. The secrecy inquiry device 10 performs processing of pseudonymization on the prompt to conceal the personal information. It is assumed that the pseudonymization means replacement of personal information with a temporary value. The temporary value will also be referred to as a “pseudonymized tag” hereinafter. The pseudonymized tag includes, for example, an attribute and a number. In FIG. 1, the secrecy inquiry device 10 replaces “Taro Yamada”, which is a full name, “Yama-chan”, which is a nickname, and “Yamada-san”, which is a family name, with pseudonymized tags “personal name 001”, “personal name 002”, and “personal name 003”, respectively, replaces “XX company”, which is a company name, with a pseudonymized tag “organization 001”, and replaces a residence with a pseudonymized tag “address 001”.

The personal information is an example of a specific expression of an attribute, and the pseudonymized tag is an example of a general expression of an attribute.

According to the technique described above, the secrecy inquiry device 10 is enabled to make an inquiry to the external LLM in a state where the personal information is concealed.

### Decoding

The secrecy inquiry device 10 transmits the prompt subjected to the pseudonymization processing to the LLM, and receives a response to the prompt from the LLM. Since the LLM response includes pseudonymized personal information, the secrecy inquiry device 10 performs processing of decoding the pseudonymization (i.e., restoring the pseudonymized tag to the original personal information).

Consistency between a word input to the LLM and a word output from the LLM is not necessarily maintained, and the LLM may output the pseudonymized tag in an altered manner. For example, in the response from the LLM in FIG. 1, the “personal name 002” is altered as “person 002”, the “personal name 003” is altered as “personal name 03”, and the “address 001” is altered as “address 1”. The decoding processing is performed using a list of personal information and pseudonymized tags associated thereto. Thus, in a case where the alteration as described above is made, the decoding is not correctly performed. Although there is a technique of adding, to the prompt, an instruction for avoiding alteration of the pseudonymized tag, it is difficult to completely avoid the alteration of the pseudonymized tag.

In view of the above, the secrecy inquiry device 10 according to the present example embodiment performs decoding in consideration of a tendency in the alteration of the pseudonymized tag by the LLM. Specifically, the secrecy inquiry device 10 decodes the pseudonymization after correcting the altered pseudonymized tag to the original pseudonymized tag. Although details will be described later, the secrecy inquiry device 10 may restore the altered pseudonymized tag to the original pseudonymized tag by estimating the tendency in the alteration of the pseudonymized tag by the LLM or by using a dictionary indicating the tendency in the alteration of the pseudonymized tag.

According to the technique described above, the secrecy inquiry device 10 is enabled to appropriately decode the response obtained from the LLM.

### Hardware Configuration

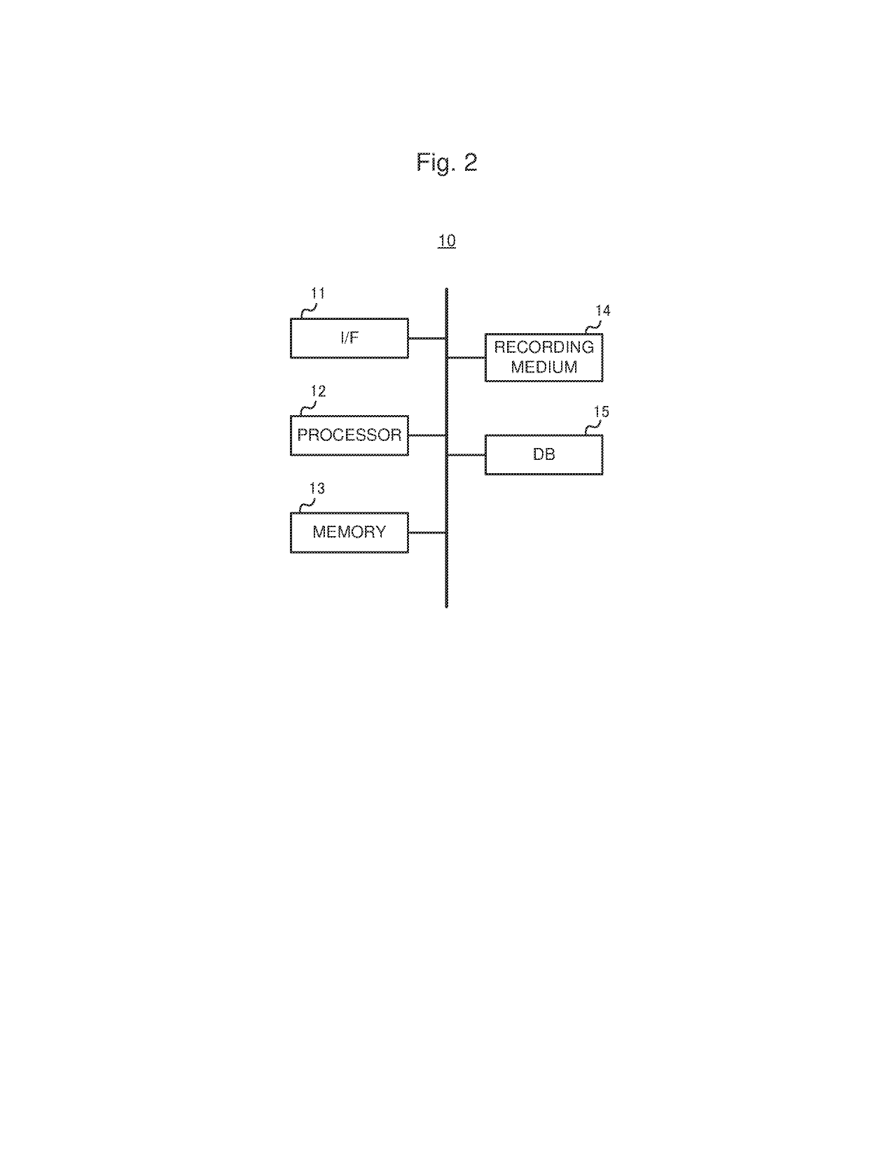

FIG. 2 is a block diagram illustrating a hardware configuration of the secrecy inquiry device 10 according to the first example embodiment. As illustrated in the drawing, the secrecy inquiry device 10 includes an interface (I/F) 11, a processor 12, a memory 13, a recording medium 14, and a database (DB) 15.

The I/F 11 exchanges data with the terminal device 5. Specifically, the I/F 11 receives a prompt from the terminal device 5, and transmits an LLM response to the terminal device 5. The I/F 11 communicates with the external LLM service through a network such as the Internet.

The processor 12 is a computer such as a central processing unit (CPU), and takes overall control of the secrecy inquiry device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes a pseudonymization process and a decoding process to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the secrecy inquiry device 10. The recording medium 14 records various programs to be executed by the processor 12. In a case where the secrecy inquiry device 10 executes various types of processing, a program recorded in the recording medium 14 is loaded into the memory 13, and is executed by the processor 12.

The DB 15 stores, for example, a table in which personal information and pseudonymized tags are associated with each other, a table (dictionary) in which pseudonymized tags and altered pseudonymized tags are associated with each other, and the like.

The secrecy inquiry device 10 may include, in addition to the above, a display device such as a liquid crystal display, and an input device such as a keyboard or a mouse. For example, the display device and input device are used by an administrator of the secrecy inquiry device 10 to perform necessary management.

### Functional Configuration

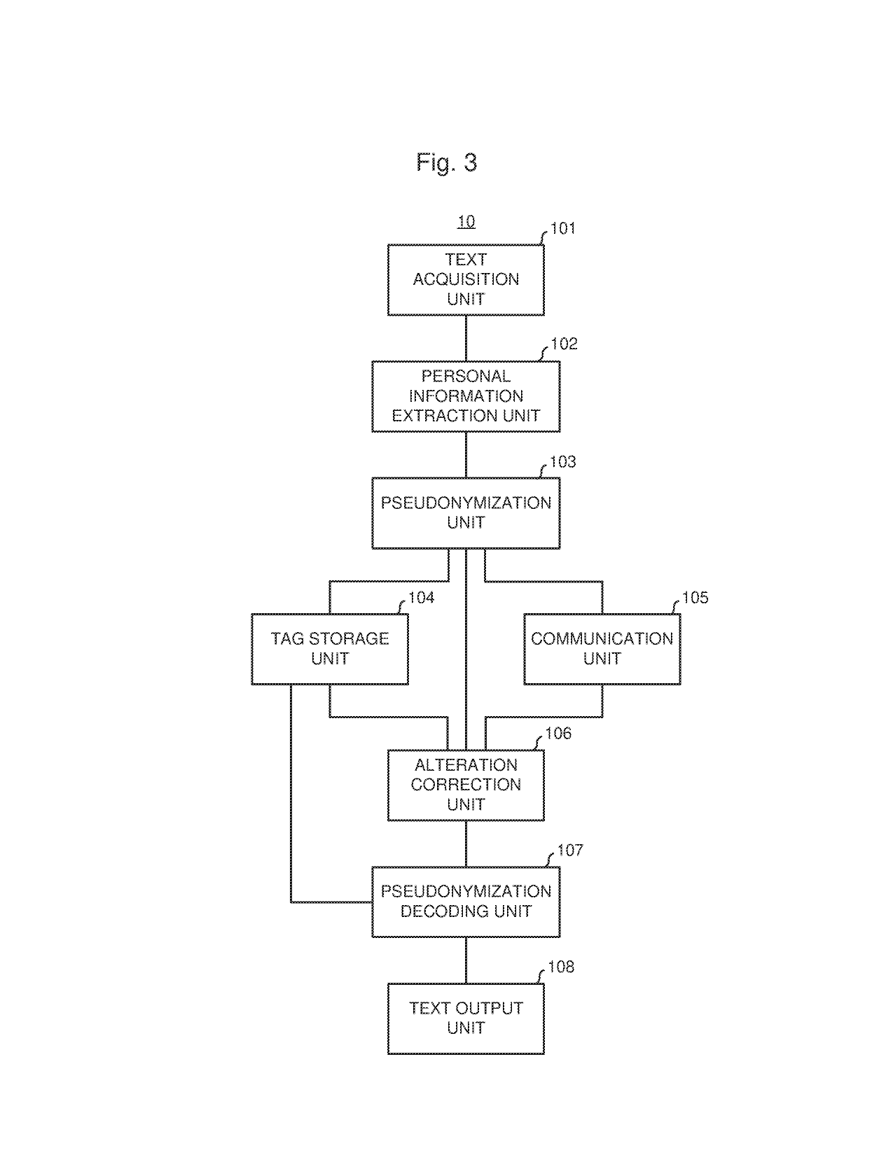

FIG. 3 is a block diagram illustrating a functional configuration of the secrecy inquiry device 10 according to the first example embodiment. The secrecy inquiry device 10 functionally includes a text acquisition unit 101, a personal information extraction unit 102, a pseudonymization unit 103, a tag storage unit 104, a communication unit 105, an alteration correction unit 106, a pseudonymization decoding unit 107, and a text output unit 108.

The tag storage unit 104 is achieved by the DB 15 illustrated in FIG. 2. The text acquisition unit 101, the personal information extraction unit 102, the pseudonymization unit 103, the communication unit 105, the alteration correction unit 106, the pseudonymization decoding unit 107, and the text output unit 108 include the processor 12 illustrated in FIG. 2.

The secrecy inquiry device 10 receives a prompt from the terminal device 5 through the I/F 11. The prompt is input to the text acquisition unit 101. The text acquisition unit 101 outputs the prompt to the personal information extraction unit 102.

The personal information extraction unit 102 extracts personal information from the prompt using, for example, a personal information extraction model. The personal information extraction model is a machine learning model trained using a data set in which labels of a personal name, an organization name, a job title, a place name, and the like are assigned to personal information in text. The personal information extraction model uses text as an input, and extracts personal information in the text for each attribute, such as a personal name, an organization name, a job title, a place name, or the like. The personal information extraction unit 102 outputs the extracted personal information to the pseudonymization unit 103.

The pseudonymization unit 103 replaces the extracted personal information with a pseudonymized tag, thereby executing the pseudonymization processing. The pseudonymized tag is created in accordance with a predetermined naming rule (composition rule). In the present example embodiment, a composition of attribute + number (three-digit display format) is used as a naming rule of the pseudonymized tag. The attribute mentioned above indicates an attribute of the personal information. The number mentioned above is assigned in such a way that personal information having the same attribute may be uniquely identified. For example, in a case where “Taro Yamada”, “Yama-chan”, and “XX company” are included in the text as personal information, the pseudonymization unit 103 replaces “Taro Yamada”, which is a personal name, with “personal name 001”, and replaces “Yama-chan”, which is a personal name different from Taro Yamada, with “personal name 002”. The pseudonymization unit 103 further replaces “XX company”, which is an organization name, with “organization 001”.

The pseudonymization unit 103 outputs, to the tag storage unit 104, a pair of the personal information and the pseudonymized tag associated thereto. The pseudonymization unit 103 outputs the prompt subjected to the pseudonymization processing to the communication unit 105 and to the alteration correction unit 106.

The tag storage unit 104 stores the pair of the personal information and the pseudonymized tag for each prompt.

The communication unit 105 transmits the prompt input from the pseudonymization unit 103 to the external LLM through the I/F 11, and receives a response to the prompt from the external LLM. At this time, the communication unit 105 may add, to the prompt, an instruction such as “please summarize”. The communication unit 105 may further add, to the prompt, an instruction such as “please output the word of personal name 001 as it is without making alteration” to avoid alteration as much as possible. The communication unit 105 outputs the LLM response to the alteration correction unit 106.

The alteration correction unit 106 corrects the LLM response. Specifically, the alteration correction unit 106 detects an altered pseudonymized tag from the LLM response based on the pseudonymized tag stored in the tag storage unit 104 and the LLM response. Then, the alteration correction unit 106 corrects the altered pseudonymized tag to the original pseudonymized tag. The alteration correction unit 106 outputs the corrected LLM response (which will also be referred to as a “corrected response” hereinafter) to the pseudonymization decoding unit 107.

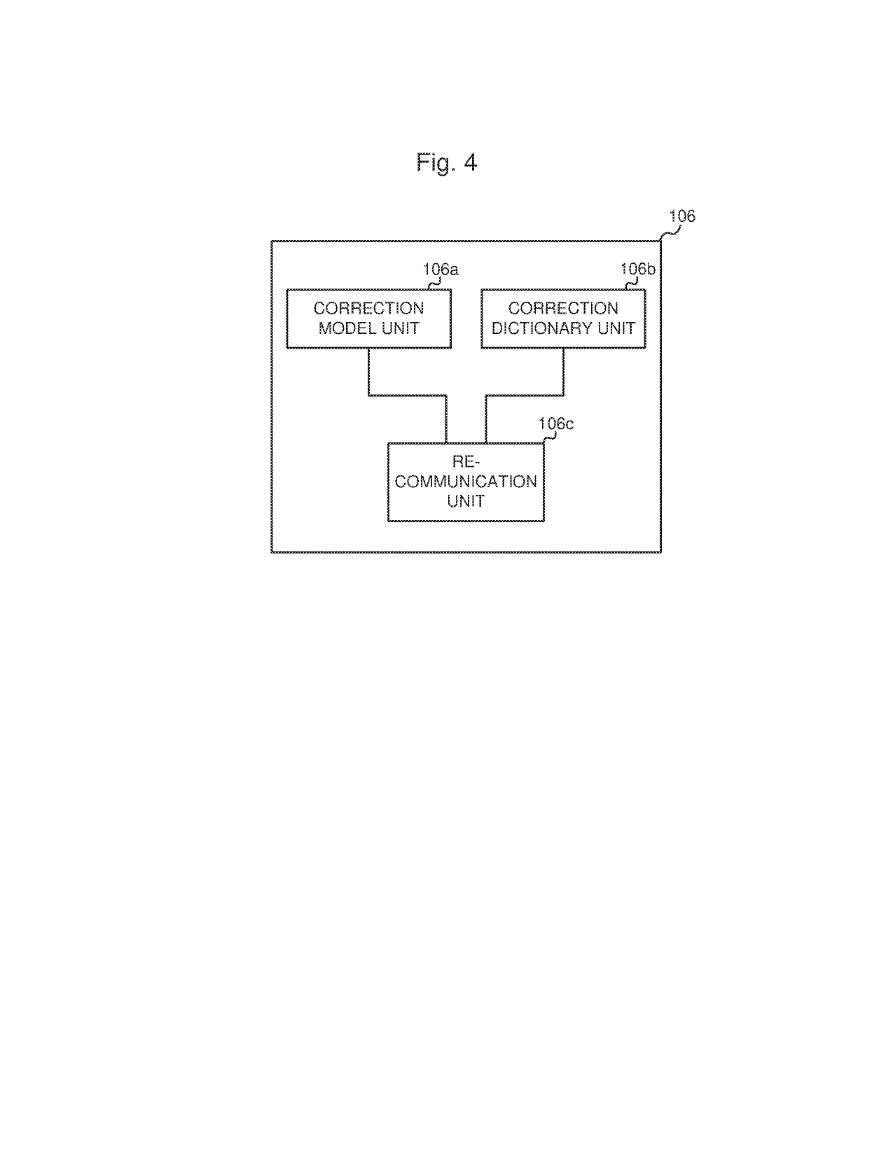

FIG. 4 is a diagram for explaining the processing by the alteration correction unit 106. In FIG. 4, the alteration correction unit 106 includes a correction model unit 106a, a correction dictionary unit 106b, and a re-communication unit 106c. The alteration correction unit 106 may include both the correction model unit 106a and the correction dictionary unit 106b, or may include only one of them.

The correction model unit 106a estimates an altered pseudonymized tag from the pseudonymized tag using at least one of the following models (1) to (3), and associates the pseudonymized tag with the altered pseudonymized tag. Then, in a case where the altered pseudonymized tag is included in the LLM response, the correction model unit 106a corrects it to the original pseudonymized tag using the association mentioned above. The correction model unit 106a outputs the corrected LLM response (corrected response) to the re-communication unit 106c.

### 1 Model Based on Predetermined Rule

The correction model unit 106a compares pairs of the pseudonymized tags stored in the tag storage unit 104 and the words in the LLM response with a predetermined rule, thereby estimating whether each word is a altered pseudonymized tag.

Specifically, as an example, it is assumed here that the predetermined rule includes “if an attribute name, a number, and a sequence thereof match, the same word is indicated”. For example, with regard to “personal name 001” and “personal name 01”, only notation of the numbers is different, and the attribute names, numbers, and sequence thereof match. Thus, according to the rule described above, “personal name 001” and “personal name 01” are estimated to be the same word. As a result, in a case where the pseudonymized tag includes “personal name 001” and the LLM response includes “personal name 01”, the correction model unit 106a may estimate that “personal name 01” is an alteration of the pseudonymized tag “personal name 001”.

In addition to the above, the correction model unit 106a may detect a word relevant to a predetermined regular expression from the LLM response, and may estimate the detected word as an altered pseudonymized tag.

### 2 Model for Calculating Edit Distance (Levenshtein Distance) between Words

The correction model unit 106a calculates similarity between the pseudonymized tags stored in the tag storage unit 104 and the words in the LLM response. The correction model unit 106a estimates, based on the similarity, whether the word in the LLM response is a altered pseudonymized tag. Specifically, the correction model unit 106a according to the present example embodiment uses an edit distance as an index for measuring the similarity between words. The correction model unit 106a calculates an edit distance between the pseudonymized tags stored in the tag storage unit 104 and the words in the LLM response. Then, in a case where there is a word whose edit distance to a certain pseudonymized tag is equal to or less than a predetermined threshold, the correction model unit 106a estimates that the word is a altered pseudonymized tag.

### 3 Machine Learning Model such as Transformer

The correction model unit 106a may estimate an altered pseudonymized tag from the pseudonymized tag using a machine learning model that has learned a relationship between a word before alteration and a word after alteration. As training data for the machine learning model described above, a pair of character strings having a short edit distance, a dictionary to be described later, or the like is used. For example, in a case where the correction model unit 106a inputs the pseudonymized tag “personal name 001” to the machine learning model, it may obtain a response such as “person_001” or “full name 001” from the machine learning model. The correction model unit 106a may estimate those responses as altered pseudonymized tags.

Next, the correction dictionary unit 106b corrects the altered pseudonymized tag in the LLM response to the original pseudonymized tag using a dictionary prepared in advance. The correction dictionary unit 106b outputs the corrected response to the re-communication unit 106c. The dictionary mentioned above is a dictionary in which a pseudonymized tag and one or a plurality of altered pseudonymized tags are associated with each other, and is created using at least one of the following techniques (4) and (5).

### 4 Dictionary Creation by LLM

The correction dictionary unit 106b inputs the following prompt to the LLM to obtain a variation of the pseudonymized tag that may be altered. The pseudonymized tag stored in the tag storage unit 104 is inserted in {pseudonymized tag}.

### Exemplary Prompt

Output a word obtained by slightly altering {pseudonymized tag} in the following format.

“Word before alteration: {pseudonymized tag}, word after alteration: {altered pseudonymized tag}”

The correction dictionary unit 106b performs the processing described above once or a plurality of times on each pseudonymized tag. Then, the correction dictionary unit 106b creates a dictionary including a pair of {pseudonymized tag} and {altered pseudonymized tag}.

### 5 Dictionary Creation by User

The correction dictionary unit 106b may obtain altered pseudonymized tags from the user to create a dictionary. It is assumed that the user collects the altered pseudonymized tags at a time of using a system for performing pseudonymization.

Next, the re-communication unit 106c receives a corrected response from the correction model unit 106a and the correction dictionary unit 106b. The re-communication unit 106c determines whether the alteration of the pseudonymized tags is sufficiently corrected. For example, in a case where the corrected response includes equal to or more than a predetermined number of or a predetermined ratio of words that have not been restored to the original pseudonymized tags, the re-communication unit 106c determines that the alteration of the pseudonymized tags is not sufficiently corrected. Specifically, in a case where the prompt before being transmitted to the LLM includes three pseudonymized tags of “personal name 001”, “organization 001”, and “personal name 002” and the corrected response includes three words of “full name 01”, “company 01”, and “person 002”, which include combinations of nouns and numbers (i.e., which are similar to the pseudonymized tags), the re-communication unit 106c determines that an unknown alteration that may not be corrected by the processing of the correction model unit 106a and the correction dictionary unit 106b has occurred with respect to the three words, and that the alteration of the pseudonymized tags has not been sufficiently corrected.

In a case where it is determined that the alteration of the pseudonymized tags is not sufficiently corrected, the re-communication unit 106c transmits, through the I/F 11, the prompt input from the pseudonymization unit 103 to the external LLM again, and obtains a response from the external LLM. Then, the re-communication unit 106c outputs the LLM response to the correction model unit 106a and to the correction dictionary unit 106b. On the other hand, in a case where it is determined that the alteration of the pseudonymized tags is sufficiently corrected, the re-communication unit 106c outputs the corrected response to the pseudonymization decoding unit 107.

Returning to FIG. 3, the pseudonymization decoding unit 107 decodes the corrected response based on the pairs of the personal information and the pseudonymized tags stored in the tag storage unit 104. The pseudonymization decoding unit 107 outputs the decoded response to the text output unit 108. The text output unit 108 transmits the decoded response to the terminal device 5 of the user.

In the configuration described above, the text acquisition unit 101, the personal information extraction unit 102, the pseudonymization unit 103, and the tag storage unit 104 are an example of a generalization means, the communication unit 105 is an example of a communication means, the alteration correction unit 106 is an example of a correction means, and the pseudonymization decoding unit 107 and the text output unit 108 are an example of a decoding means.

### Processing Flow

### Pseudonymization Process and Decoding Process

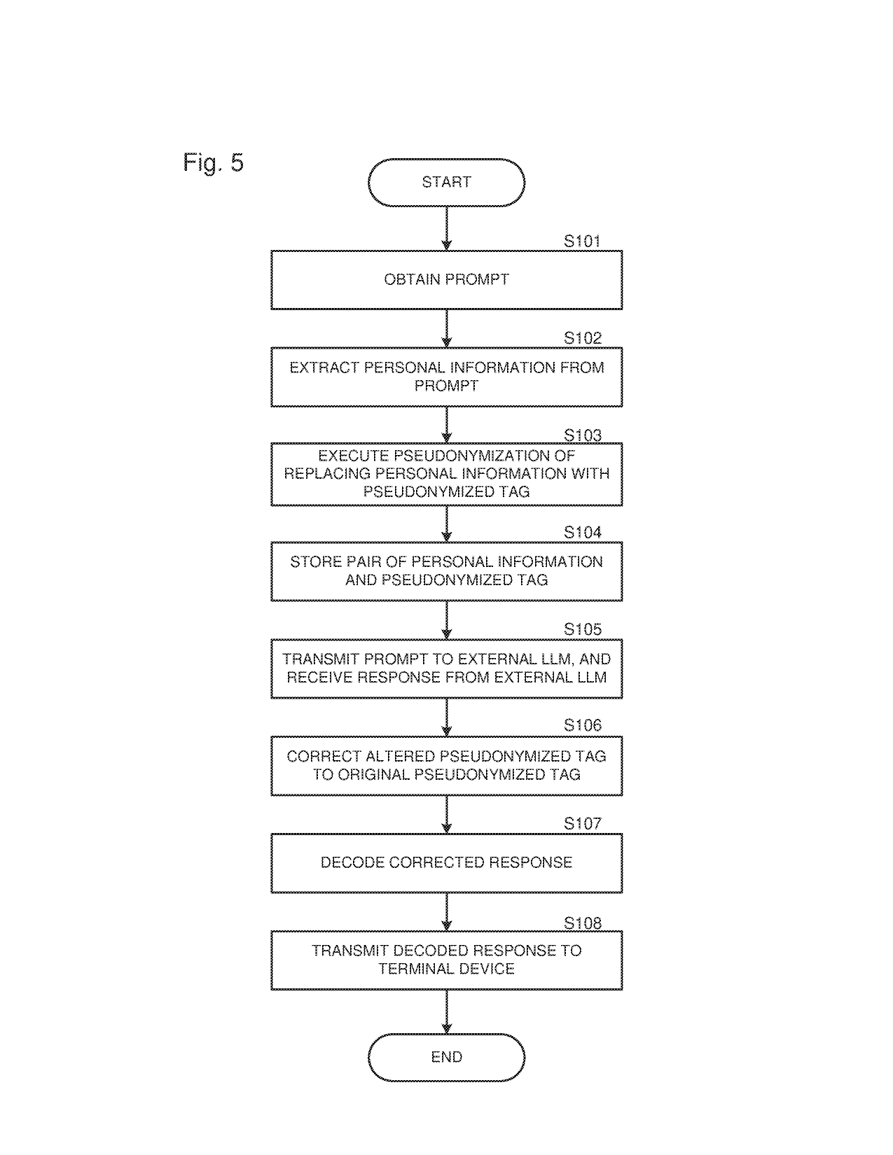

Next, the pseudonymization process and the decoding process to be performed by the secrecy inquiry device 10 will be described. FIG. 5 is a flowchart of the pseudonymization process and the decoding process to be performed by the secrecy inquiry device 10. This process is achieved by the processor 12 illustrated in FIG. 2 executing a program prepared in advance and operating as each element illustrated in FIG. 3.

The secrecy inquiry device 10 receives a prompt from the terminal device 5 through the I/F 11. The prompt is input to the text acquisition unit 101 (step S101). The text acquisition unit 101 outputs the prompt to the personal information extraction unit 102.

Next, the personal information extraction unit 102 extracts personal information from the prompt using the personal information extraction model (step S102). The personal information extraction model is a machine learning model that uses text as an input and extracts personal information in the text for each attribute, such as a personal name, an organization name, a job title, a place name, or the like. The personal information extraction unit 102 outputs the extracted personal information to the pseudonymization unit 103.

Next, the pseudonymization unit 103 replaces the extracted personal information with a pseudonymized tag, thereby executing the pseudonymization processing (step S103). The pseudonymization unit 103 uses a combination of an attribute and a number as a pseudonymized tag. The pseudonymization unit 103 outputs, to the tag storage unit 104, a pair of the personal information and the pseudonymized tag associated thereto. The pseudonymization unit 103 outputs the prompt subjected to the pseudonymization processing to the communication unit 105 and to the alteration correction unit 106.

The tag storage unit 104 stores the pair of the personal information and the pseudonymized tag (step S104). The communication unit 105 transmits the prompt input from the pseudonymization unit 103 to the external LLM through the I/F 11, and receives a response to the prompt from the external LLM (step S105). The communication unit 105 outputs the LLM response to the alteration correction unit 106.

Next, if the LLM response includes an altered pseudonymized tag, the alteration correction unit 106 corrects it to the original pseudonymized tag (step S106). The alteration correction unit 106 outputs the corrected response to the pseudonymization decoding unit 107.

Next, the pseudonymization decoding unit 107 decodes the corrected response based on the pairs of the personal information and the pseudonymized tags stored in the tag storage unit 104 (step S107). The pseudonymization decoding unit 107 outputs the decoded response to the text output unit 108. Next, the text output unit 108 transmits the decoded response to the terminal device 5 of the user (step S108). Then, the process is terminated. Step S104 may be executed before step S105, or may be executed simultaneously with step S105.

### Pseudonymized Tag Correction Process

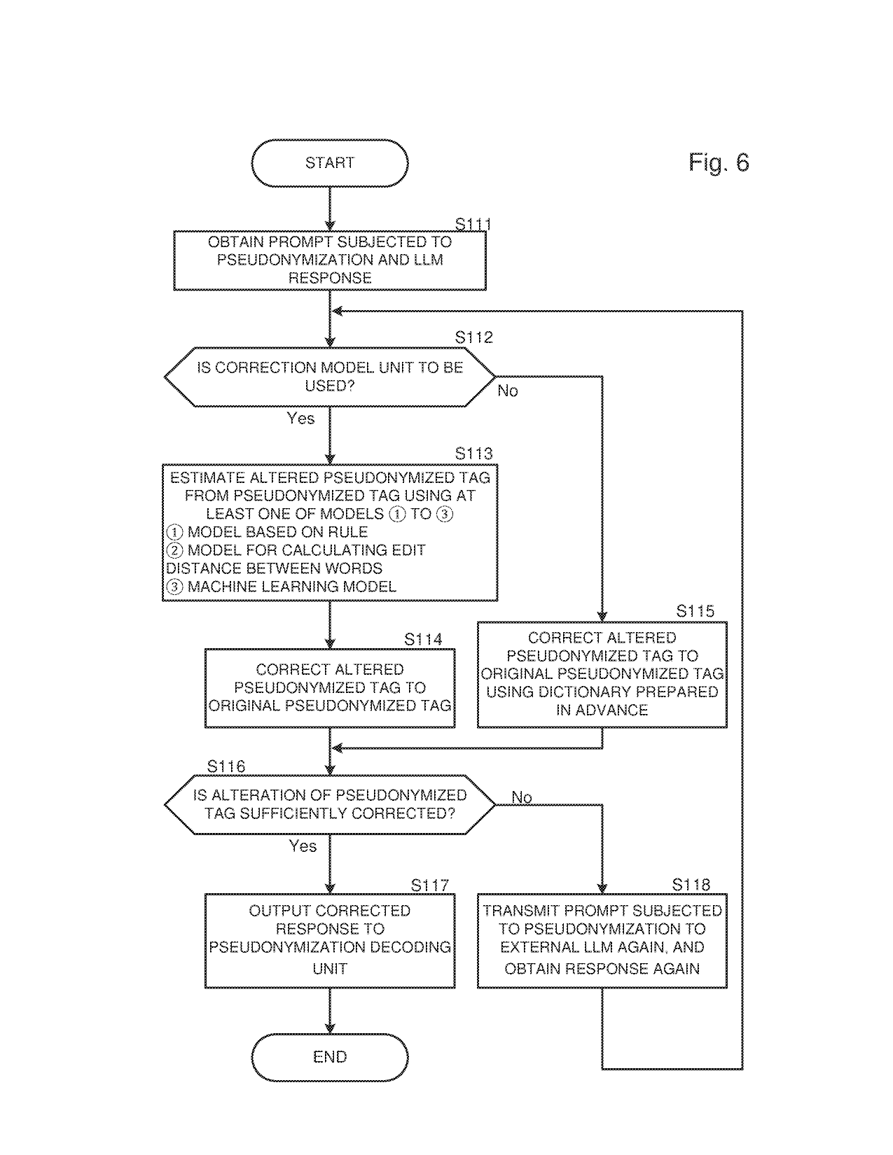

Next, the process of correcting the pseudonymized tag to be performed by the alteration correction unit 106 will be described. FIG. 6 is a flowchart of the process to be performed by the alteration correction unit 106. This process is achieved by the processor 12 illustrated in FIG. 2 executing a program prepared in advance and operating as each element illustrated in FIG. 4.

The alteration correction unit 106 receives the prompt subjected to the pseudonymization processing from the pseudonymization unit 103, and receives the LLM response from the communication unit 105 (step S111). The alteration correction unit 106 selects whether to use the correction model unit 106a or the correction dictionary unit 106b (step S112). In a case of using the correction model unit 106a (Yes in step S112), the alteration correction unit 106 outputs the LLM response to the correction model unit 106a. On the other hand, in a case of using the correction dictionary unit 106b (No in step S112), the alteration correction unit 106 outputs the LLM response to the correction dictionary unit 106b.

The correction model unit 106a estimates an altered pseudonymized tag from the pseudonymized tag using at least one of the model based on the predetermined rule, the model for calculating an edit distance between words, and the machine learning model such as Transformer (step S113). Then, if an altered pseudonymized tag is included in the LLM response, the correction model unit 106a corrects it to the original pseudonymized tag, and creates a corrected response (step S114). The correction model unit 106a outputs the corrected response to the re-communication unit 106c.

The correction dictionary unit 106b corrects the altered pseudonymized tag in the LLM response to the original pseudonymized tag using a dictionary prepared in advance, and creates a corrected response (step S115). The correction dictionary unit 106b outputs the corrected response to the re-communication unit 106c.

The re-communication unit 106c determines whether the alteration of the pseudonymized tags is sufficiently corrected (step S116). If it is determined that the alteration of the pseudonymized tags is sufficiently corrected (Yes in step S116), the re-communication unit 106c outputs the corrected response to the pseudonymization decoding unit 107 (step S117). On the other hand, if it is determined that the alteration of the pseudonymized tags is not sufficiently corrected (No in step S116), the re-communication unit 106c transmits the prompt subjected to the pseudonymization processing to the external LLM again, and obtains a response from the external LLM again (step S118). Then, the process returns to step S112.

While the alteration correction unit 106 selects either the correction model unit 106a or the correction dictionary unit 106b in step S112, the alteration correction unit 106 may select both the correction model unit 106a and the correction dictionary unit 106b. In that case, the processing by the correction model unit 106a (steps S113 and S114) and the processing by the correction dictionary unit 106b (step S115) are performed in parallel.

### Application Example

Next, an application example of the secrecy inquiry device 10 according to the present example embodiment will be described. The secrecy inquiry device 10 may be applied to a company, a local government, a medical institution, and the like that handle customer information. For example, by using the secrecy inquiry device 10, a company or a local government that handles customer information is enabled to transmit, to an external LLM, an instruction regarding text generation or text summarization while concealing personal information of customers such as a name, an occupation, a date of birth, and the like. By using the secrecy inquiry device 10, a medical institution is enabled to transmit, to an external LLM, an instruction regarding a case search or medical record generation while concealing a name, a date of birth, and the like of a patient.

### Modification

Next, modified examples of the first example embodiment will be described. The following modified examples may be appropriately combined and applied to the first example embodiment.

### Modification 1

While the secrecy inquiry device 10 according to the present example embodiment conceals the personal information included in the text, the target to be concealed is not limited thereto. The secrecy inquiry device 10 may conceal information other than the personal information included in the text. Examples of the information other than the personal information include nouns other than the personal information, such as gender, and numbers, such as age, height and weight, numerical values of medical examination, and date and time. The secrecy inquiry device 10 may conceal confidential information of a company (trade secrecy) as the information other than the personal information. Examples of the trade secrecy include information regarding customers, personnel affairs, suppliers, and the like. For example, the secrecy inquiry device 10 may replace the specific expressions of the attributes as described above with general expressions, such as “gender 001” and “age 001”, and may transmit them to the external LLM.

### Modification 2

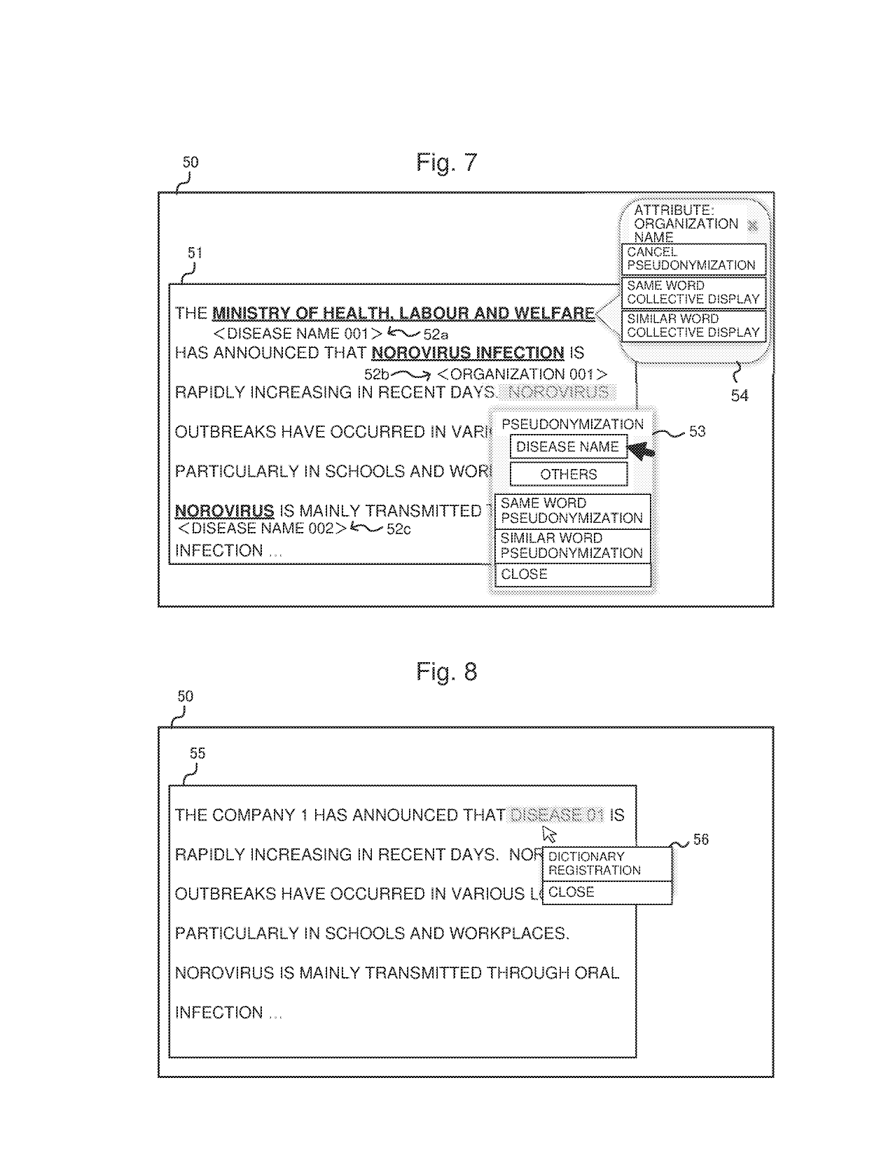

The secrecy inquiry device 10 according to the present example embodiment may transmit the prompt subjected to the pseudonymization processing to the terminal device 5 in such a way that the user may check and correct the result of the pseudonymization. FIG. 7 is an example of a confirmation screen. In FIG. 7, a prompt 51, pseudonymized tags 52a to 52c, an additional menu 53, and a deletion menu 54 are displayed on a display 50 of the terminal device. The prompt 51 is a prompt subjected to the pseudonymization processing. The prompt 51 includes the pseudonymized tags 52ato 52c. As illustrated in FIG. 7, the secrecy inquiry device 10 assigns the pseudonymized tag 52a to “norovirus infection”, assigns the pseudonymized tag 52b to “Ministry of Health, Labour and Welfare”, and assigns the pseudonymized tag 52c to “norovirus” in the fourth line.

The terminal device 5 corrects the pseudonymized tags in accordance with an operation made by the user, and transmits them to the secrecy inquiry device 10. In FIG. 7, addition and deletion of a pseudonymized tag are illustrated as an example of correction. The additional menu 53 is a menu for adding a pseudonymized tag, and is displayed, for example, in a case where the user drags and selects a word to be pseudonymized. The user selects an attribute of the word to be pseudonymized from the additional menu 53, and adds a pseudonymized tag. In FIG. 7, the user selects “norovirus” as a word to be pseudonymized, and selects “disease name” as an attribute. A number following the attribute may be assigned by the user, or may be assigned by the secrecy inquiry device 10.

The deletion menu 54 is a menu for deleting a pseudonymized tag, and is displayed, for example, in a case where the user selects a pseudonymized tag to be deleted. The user may delete a pseudonymized tag by selecting a “cancel pseudonymization” button from the deletion menu 54.

### Modification 3

The secrecy inquiry device 10 may provide the terminal device 5 with a registration screen of a altered pseudonymized tag to collect altered pseudonymized tags from the user. FIG. 8 is an example of the registration screen. In FIG. 8, a decoded response 55 and a registration menu 56 are displayed on the display 50 of the terminal device. The decoded response 55 is text obtained by decoding the LLM response. In FIG. 8, the decoded response 55 includes words that seem to be altered pseudonymized tags, such as “disease 01”, “company 1”, and the like. The registration menu 56 is a menu for registering a altered pseudonymized tag, and is displayed, for example, in a case where the user drags and selects a word that seems to be an altered pseudonymized tag. According to such display, the secrecy inquiry device 10 may collect pseudonymized tags subjected to unknown alteration from the user, and may create a dictionary to be used by the correction dictionary unit 106b.

### Second Example Embodiment

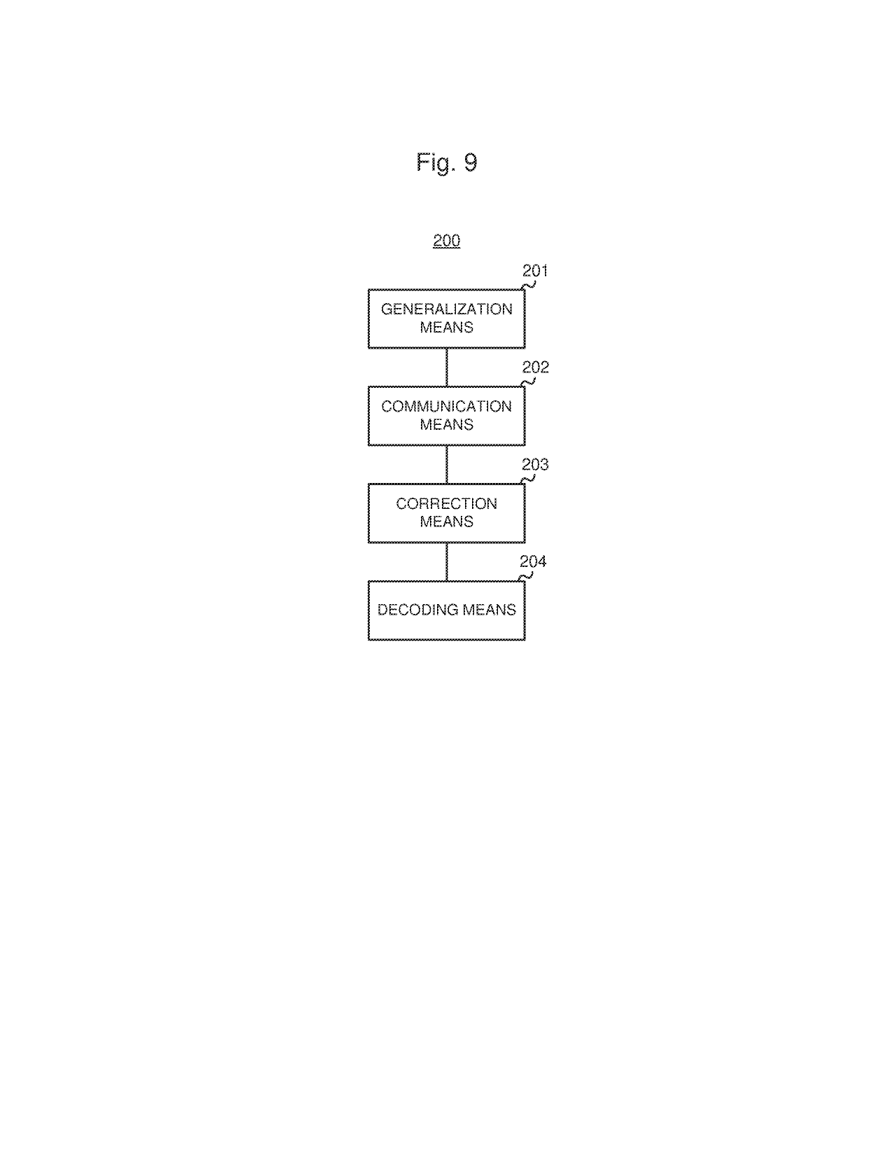

FIG. 9 is a block diagram illustrating a functional configuration of a secrecy inquiry device according to a second example embodiment. A secrecy inquiry device 200 includes a generalization means 201, a communication means 202, a correction means 203, and a decoding means 204.

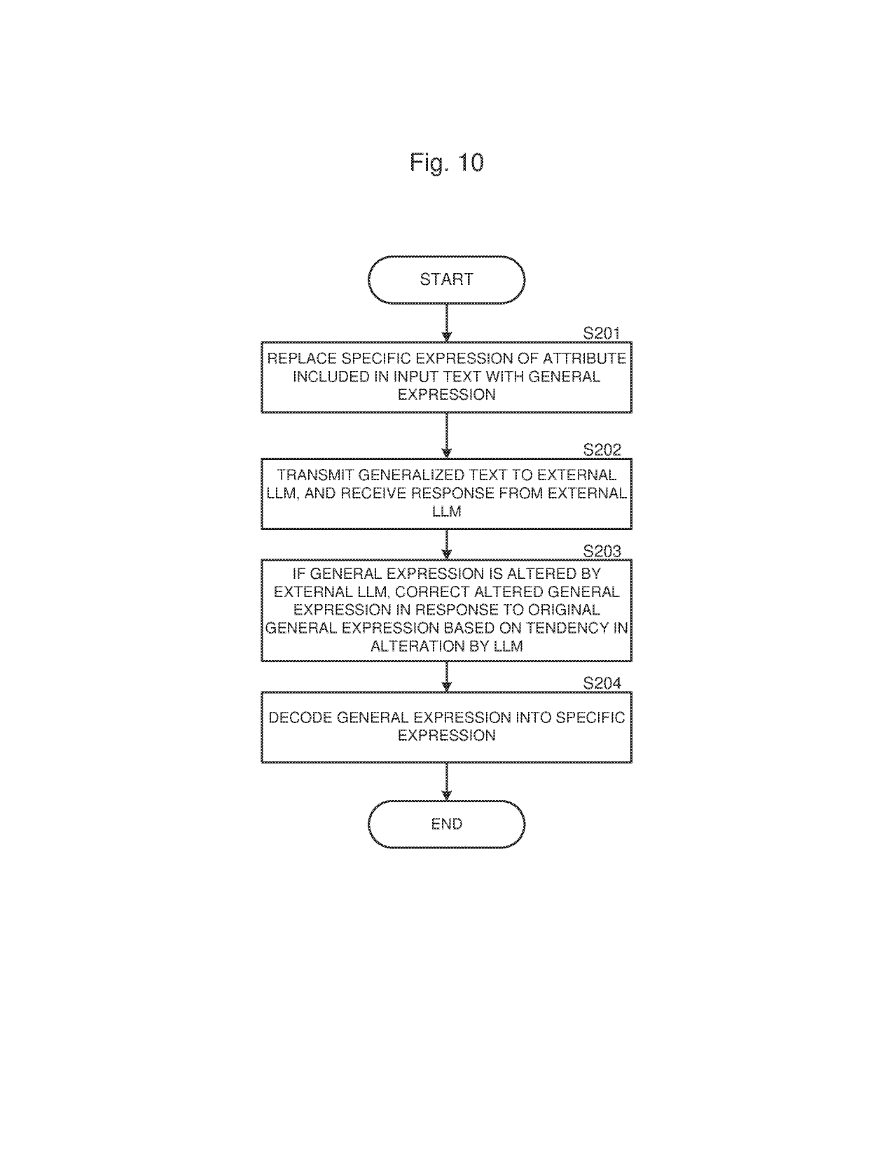

FIG. 10 is a flowchart of a process to be performed by the secrecy inquiry device according to the second example embodiment. The generalization means 201 replaces a specific expression of an attribute included in input text with a general expression (step S201). The communication means 202 transmits the text replaced with the general expression to an external LLM, and receives a response from the external LLM (step S202). If the general expression is altered by the external LLM, the correction means 203 corrects the altered general expression in the response to the original general expression based on a tendency in the alteration by the LLM (step S203). The decoding means 204 decodes the general expression into the specific expression (step S204).

According to the secrecy inquiry device 200 according to the second example embodiment, concealed text may be transmitted to an LLM, and a response obtained from the LLM may be appropriately decoded.

Some or all of the example embodiments described above may also be described as, but are not limited to, the following Supplementary Notes.

### Supplementary note 1

A secrecy inquiry device comprising:

a generalization means for replacing a specific expression of an attribute included in input text with a general expression;

a communication means for transmitting the text in which the specific expression is replaced with the general expression to an external LLM and receiving a response from the external LLM;

a correction means for correcting, in a case where the general expression is altered by the external LLM, the altered general expression in the response to the original general expression based on a tendency in alteration by an LLM; and

a decoding means for decoding the general expression into the specific expression.

### Supplementary note 2

The secrecy inquiry device according to supplementary note 1, wherein the specific expression of the attribute includes personal information or a trade secret.

### Supplementary note 3

The secrecy inquiry device according to supplementary note 1, wherein

the correction means includes both or one of:

a model correction means for estimating alteration of the general expression from the general expression and correcting the altered general expression to the original general expression based on an estimation result; and

a dictionary correction means for correcting the altered general expression to the original general expression using a dictionary in which the general expression and one or a plurality of the altered general expressions are associated with each other.

### Supplementary note 4

The secrecy inquiry device according to supplementary note 3, wherein

the correction means further includes a re-communication means for re-transmitting the generalized text to the external LLM based on a correction result of the model correction means or the dictionary correction means and receiving a response from the external LLM again, and

the correction means corrects the altered general expression in the response received again to the original general expression.

### Supplementary note 5

The secrecy inquiry device according to supplementary note 3, wherein

the model correction means estimates the altered general expression from a word included in the response based on a predetermined rule, and

the predetermined rule is determined based on a composition rule of the general expression.

### Supplementary note 6

The secrecy inquiry device according to supplementary note 3, wherein the model correction means estimates a word in the response having similarity to the general expression equal to or less than a predetermined threshold as the altered general expression.

### Supplementary note 7

The secrecy inquiry device according to supplementary note 3, wherein the model correction means estimates the altered general expression from a word included in the response using a machine learning model that has learned a relationship between a word before alteration and the word after the alteration.

### Supplementary note 8

The secrecy inquiry device according to supplementary note 3, wherein the dictionary correction means creates the dictionary by inputting a prompt for instructing the alteration of the general expression to the LLM and obtaining the one or a plurality of altered general expressions as a response from the LLM.

### Supplementary note 9

The secrecy inquiry device according to supplementary note 3, wherein the dictionary correction means collects altered general expressions from a user and generates the dictionary based on the general expression and collection results from the user.

### Supplementary note 10

The secrecy inquiry device according to supplementary note 7, wherein the machine learning model uses, as training data, either pairs of strings having a similarity below a predetermined threshold, or the dictionary.

### Supplementary note 11

The secrecy inquiry device according to supplementary note 4, wherein the re-communication means re-transmits the generalized text to the external LLM, in a case where a predetermined number or more of words, similar to the general expression and not corrected to the general expression, are included in the response corrected by the model correction means or the dictionary correction means.

### Supplementary note 12

A secrecy inquiry method to be executed by a computer, the method comprising:

replacing a specific expression of an attribute included in input text with a general expression;

transmitting the text in which the specific expression is replaced with the general expression to an external LLM and receiving a response from the external LLM;

correcting, in a case where the general expression is altered by the external LLM, the altered general expression in the response to the original general expression based on a tendency in alteration by an LLM; and

decoding the general expression into the specific expression.

### Supplementary note 13

A program for causing a computer to perform a process comprising:

replacing a specific expression of an attribute included in input text with a general expression;

transmitting the text in which the specific expression is replaced with the general expression to an external LLM and receiving a response from the external LLM;

correcting, in a case where the general expression is altered by the external LLM, the altered general expression in the response to the original general expression based on a tendency in alteration by an LLM; and

decoding the general expression into the specific expression.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

### 5 terminal device

10 secrecy inquiry device

101 text acquisition unit

102 personal information extraction unit

103 pseudonymization unit

104 tag storage unit

105 communication unit

106 alteration correction unit

107 pseudonymization decoding unit

108 text output unit

1. A secrecy inquiry device comprising:
at least one memory configured to store instructions; and
at least one processor configured to execute the instructions to:
replace a specific expression of an attribute included in input text with a general expression;
transmit the text in which the specific expression is replaced with the general expression to an external LLM and receive a response from the external LLM;
correct, in a case where the general expression is altered by the external LLM, the altered general expression in the response to the original general expression based on a tendency in alteration by an LLM; and
decode the general expression into the specific expression.

2. The secrecy inquiry device according to claim 1, wherein the specific expression of the attribute includes personal information or a trade secret.

3. The secrecy inquiry device according to claim 1, wherein
the one or more processors are configured to perform one or both of:
estimating alteration of the general expression from the general expression and correct the altered general expression to the original general expression based on an estimation result; and
correcting the altered general expression to the original general expression using a dictionary in which the general expression and one or a plurality of the altered general expressions are associated with each other.

4. The secrecy inquiry device according to claim 3, wherein the one or more processors are further configured to re-transmit the generalized text to the external LLM based on a correction result and receive a response from the external LLM again,
wherein the one or more processors correct the altered general expression in the response received again to the original general expression.

5. The secrecy inquiry device according to claim 3, wherein
the one or more processors estimate the altered general expression from a word included in the response based on a predetermined rule, and
the predetermined rule is determined based on a composition rule of the general expression.

6. The secrecy inquiry device according to claim 3, wherein the one or more processors estimate a word in the response having similarity to the general expression equal to or less than a predetermined threshold as the altered general expression.

7. The secrecy inquiry device according to claim 3, wherein the one or more processors estimate the altered general expression from a word included in the response using a machine learning model that has learned a relationship between a word before alteration and the word after the alteration.

8. The secrecy inquiry device according to claim 3, wherein the one or more processors create the dictionary by inputting a prompt for instructing the alteration of the general expression to the LLM and obtaining the one or a plurality of altered general expressions as a response from the LLM.

9. A secrecy inquiry method comprising:
replacing a specific expression of an attribute included in input text with a general expression;
transmitting the text in which the specific expression is replaced with the general expression to an external LLM and receiving a response from the external LLM;
correcting, in a case where the general expression is altered by the external LLM, the altered general expression in the response to the original general expression based on a tendency in alteration by an LLM; and
decoding the general expression into the specific expression.

10. A non-transitory computer-readable recording medium recording a program for causing a computer to execute processing comprising:
replacing a specific expression of an attribute included in input text with a general expression;
transmitting the text in which the specific expression is replaced with the general expression to an external LLM and receiving a response from the external LLM;
correcting, in a case where the general expression is altered by the external LLM, the altered general expression in the response to the original general expression based on a tendency in alteration by an LLM; and
decoding the general expression into the specific expression.

11. The secrecy inquiry device according to claim 3, wherein the one or more processors collect altered general expressions from a user and generate the dictionary based on the general expression and collection results from the user.

12. The secrecy inquiry device according to claim 7, wherein the machine learning model uses, as training data, either pairs of strings having a similarity below a predetermined threshold, or the dictionary.

13. The secrecy inquiry device according to claim 4, wherein the one or more processors re-transmit the generalized text to the external LLM, in a case where a predetermined number or more of words, similar to the general expression and not corrected to the general expression, are included in the corrected response.
